(19) United States
(12) Patent Application Publication
(10) Pub. No.: US 2023/0219073 A1
(43) Pub. Date: Jul. 13, 2023

(54) DOPING GRADIENT-BASED PHOTOCATALYSIS

(71) Applicants: Faqrul A. Chowdhury, Ann Arbor, MI (US); The Regents of the University of Michigan, Ann Arbor, MI (US)

(72) Inventors: Zetian Mi, Ann Arbor, MI (US); Yongjie Wang, Berkeley, CA (US); Faqrul A. Chowdhury, Montreal (CA)

(21) Appl. No.: 17/914,597

(22) PCT Filed: Mar. 26, 2021
(86) PCT No.: PCT/US2021/024339

§ 371 Date: Sep. 26, 2022

Related U.S. Application Data
(60) Provisional application No. 62/994,981, filed on Mar. 26, 2020.

(51) Int. Cl. B01J 35/00; B01J 27/24; B01J 23/75; B01J 23/46; B01J 37/02; B01J 37/06; B01J 19/12; B01J 19/08; C01B 3/04

(52) U.S. Cl. CPC B01J 35/004; B01J 35/0033; B01J 35/0013; B01J 27/24; B01J 23/75; B01J 23/464; B01J 37/0228; B01J 37/0244; B01J 37/06; B01J 19/122; B01J 19/088; C01B 3/042; B01J 2219/0843; B01J 2219/1203

(57) ABSTRACT

A photocatalytic device includes a substrate having a surface, and an array of conductive projections supported by the substrate and extending outward from the surface of the substrate. Each conductive projection of the array of conductive projections has a semiconductor composition. The semiconductor composition establishes a photochemical diode. The surface may be nonplanar such that subsets of the array of conductive projections are oriented at different angles.

### CROSS-REFERENCE TO RELATED APPLICATION

This application claims the benefit of U.S. provisional application entitled “Doping Gradient-Based Photocatalysis,” filed Mar. 26, 2020, and assigned Ser. No. 62/994,981, the entire disclosure of which is hereby expressly incorporated by reference.

### STATEMENT REGARDING FEDERALLY SPONSORED RESEARCH OR DEVELOPMENT

This invention was made with government support under Grant No. CBET 1804458 awarded by the National Science Foundation. The government has certain rights in the invention.

### BACKGROUND OF THE DISCLOSURE

### Field of the Disclosure

The disclosure relates generally to photocatalytic systems.

### Brief Description of Related Technology

Photocatalytic water splitting is directed to converting solar energy directly to hydrogen fuels. Photocatalytic water splitting may be considered to implement artificial photosynthesis. Unlike photoelectrochemical water splitting that generally involves the positioning of two (photo)electrodes in a highly conductive electrolyte, water redox reactions in photocatalytic overall water splitting may occur on the same surfaces of a light absorber in nearly pH neutral solutions, such as pure water or seawater, thereby promising large scale practical application.

Direct photocatalytic water splitting involves the electronic band structures of the semiconductor light absorbers, such that the conduction and valence band edges, straddling the water redox potentials with sufficient chemical overpotentials for proton reduction and water oxidation reactions, respectively. The energy bandgap may also be tailored for efficient sunlight harvesting. In spite of intensive studies on photocatalytic water splitting, most of the semiconductor light absorbers reported to date do not possess suitable band edge positions for overall water splitting under visible light illumination. For example, metal oxides, such as TiO₂, InNiTaO₄, SrTiO₃, GaN/ZnO, and LaMgTaO₂, are capable of only absorbing a small part of the solar spectra due to large bandgaps. In contrast, narrow bandgap semiconductors, such as Si, GaAs, and InP, do not possess suitable band edge positions to drive overall water splitting.

Attempts to extend the energy bands of various wide bandgap materials to enhance the efficiency of photocatalytic solar water splitting, such as the utilization of black TiO₂ by metal doping, dye sensitization, or adding surface hydroxyl groups, have had limited success. To date, the solar-to-hydrogen (STH) conversion efficiency is generally limited to <0.5% for single-band metal-oxide photocatalysts. An STH efficiency up to 5% has been reported with the use of CoOₓ nanoparticles, but the stability is limited to about 30 mins. Z-scheme photocatalytic systems using two-step photo-excitation, in principle, can overcome the unsuitable energy band structures for water redox reactions. For example, SrTiO₃/BiVO₄ has been studied for improved photocatalytic performance. However, the energy conversion efficiency is still limited to about 1%.

Recently, metal-nitride semiconductors, e.g., InₓGa₁₋ₓN (noted as InGaN), have drawn significant attention for photocatalytic water splitting. The energy bandgap of InGaN materials can be continuously varied from ultraviolet, through the visible, to the near-infrared, covering nearly the entire solar spectra. Significantly, the energy band edge positions of InGaN materials can straddle water redox potentials for a large range of alloy compositions (up to indium compositions of about 40-50%), which corresponds to an energy bandgap of about 1.7-2 eV. GaN-based materials have also been widely used in electronics and photonics industries, being the second most produced semiconductor (next to only silicon).

Since the first demonstration of photocatalytic overall water splitting on GaN nanostructures, significantly improved performance has been reported by engineering the surface charge properties through p-type dopant incorporation and surface Fermi level tuning. The wide bandgap (approximately 3.4 eV) of GaN, however, greatly limits its light absorption capacity to only in the ultraviolet. To enhance its visible light absorption, InGaN has been integrated, thereby forming a double-band structure.

In addition, a magnesium (Mg) doping gradient in III-nitride nanostructures has been used to form a built-in electric field, thereby facilitating charge carrier separation and extraction. Recently, photocatalytic overall water splitting with an STH efficiency up to 3.3% has been demonstrated with the use of double-band InGaN/GaN nanowire structures. However, in these studies, the indium composition is limited to about 22% or less, corresponding to an energy gap over 2.6 eV, which is only capable of absorbing photons in the blue spectrum. While photocatalytic water splitting with photon absorption up to 560 nm has been reported for InGaN nanowire photocatalysts, the reported efficiency is still undesirably low, largely due to the inefficient separation and extraction of photo-generated charge carriers.

### SUMMARY OF THE DISCLOSURE

In accordance with one aspect of the disclosure, a photocatalytic device includes a substrate having a surface, and an array of conductive projections supported by the substrate and extending outward from the surface of the substrate. Each conductive projection of the array of conductive projections has a semiconductor composition. The semiconductor composition establishes a photochemical diode. The surface is nonplanar such that subsets of the array of conductive projections are oriented at different angles.

In accordance with another aspect of the disclosure, a photocatalytic system includes a container in which water is disposed, and a semiconductor device immersed in the water. The semiconductor device includes a substrate having a pyramidal textured surface, and an array of nanostructures supported by the substrate and extending outward from the pyramidal textured surface of the substrate, each nanostructure of the array of nanostructures having a semiconductor composition, the semiconductor composition establishing a photochemical diode. The pyramidal textured surface orients subsets of the array of nanostructures at different angles.

In accordance with yet another aspect of the disclosure, a method of fabricating a photocatalytic semiconductor device includes providing a substrate having a surface, and forming an array of nanostructures on the surface of the substrate such that each nanostructure of the array of nanostructures extends outward from the surface of the substrate, each nanostructure of the array of nanostructures having a semiconductor composition, the semiconductor composition establishing a photochemical diode. The surface is nonplanar such that subsets of the array of nanostructures are oriented at different angles.

In accordance with still another aspect of the disclosure, a photocatalytic device includes a substrate having a surface, and an array of conductive projections supported by the substrate and extending outward from the surface of the substrate. Each conductive projection of the array of conductive projections has a semiconductor composition, the semiconductor composition establishing a photochemical diode. Each conductive projection includes a cylindrically shaped nanostructure, and the semiconductor composition includes a lateral doping gradient.

In accordance with still another aspect of the disclosure, a method of fabricating a photocatalytic semiconductor device includes providing a substrate having a surface, and forming an array of nanostructures on the surface of the substrate such that each nanostructure of the array of nanostructures extends outward from the surface of the substrate. Each nanostructure of the array of nanostructures having a semiconductor composition, the semiconductor composition establishing a photochemical diode. Forming the array of nanostructures includes implementing a molecular beam epitaxy procedure in which the substrate is rotated. The semiconductor composition includes a lateral doping gradient.

In connection with any one of the aforementioned aspects, the devices, systems, and/or methods described herein may alternatively or additionally include or involve any combination of one or more of the following aspects or features. The surface includes a multi-faceted surface. The surface includes a pyramidal textured surface. Each conductive projection of the array of conductive projections includes a layered arrangement of semiconductor materials. The layered arrangement of semiconductor materials establishes a quadruple band structure. Each conductive structure of the array of conductive structures includes a first side and a second side opposite the first side. The first side faces away from the substrate. The second side faces toward the substrate. A dopant concentration of the semiconductor composition decreases from the first side to the second side to establish a lateral dopant gradient. The semiconductor composition includes indium gallium nitride doped with magnesium. Each conductive projection of the array of conductive projections includes a nanowire. The substrate includes silicon. The photocatalytic device further includes first and second pluralities of catalyst nanoparticles disposed over the array of conductive projections, the catalyst nanoparticles of the first and second pluralities of catalyst nanoparticles being disposed on a water-oxidizing anode side and a proton-reducing cathode side of each conductive projection of the array of conductive projections, respectively. Each catalyst nanoparticle of the first plurality of catalyst nanoparticles on the water-oxidizing anode side includes cobalt oxide. Each catalyst nanoparticle of the second plurality of catalyst nanoparticles on the proton-reducing cathode side includes rhodium (Rh). Each nanostructure of the array of nanostructures includes a layered arrangement of semiconductor materials. The layered arrangement of semiconductor materials establishes a quadruple band structure. Each nanostructure of the array of nanostructures includes a first side and a second side opposite the first side. The first side faces away from the substrate. The second side faces toward the substrate. A dopant concentration of the semiconductor composition decreases from the first side to the second side to establish a lateral dopant gradient. The photocatalytic system further includes first and second pluralities of catalyst nanoparticles disposed over the array of nanostructures, the catalyst nanoparticles of the first and second pluralities of catalyst nanoparticles being disposed on a water-oxidizing anode side and a proton-reducing cathode side of each nanostructure of the array of nanostructures, respectively. The semiconductor composition includes indium gallium nitride doped with magnesium. The substrate includes silicon. Each catalyst nanoparticle of the first plurality of catalyst nanoparticles on the water-oxidizing anode side includes cobalt oxide. Each catalyst nanoparticle of the second plurality of catalyst nanoparticles on the proton-reducing cathode side includes rhodium (Rh). Providing the substrate includes implementing a crystallographic etch procedure to define the surface. The crystallographic etch procedure includes a wet etch procedure. The substrate includes a silicon wafer of <100> orientation such that the wet etch procedure establishes that the surface includes a pyramidal textured surface with faces oriented along <111> planes. The method further includes depositing first and second pluralities of catalyst nanoparticles across the array of nanostructures, the catalyst nanoparticles of the first and second pluralities of catalyst nanoparticles being disposed on a water-oxidizing anode side and a proton-reducing cathode side of each nanostructure of the array of nanostructures, respectively. Depositing the first and second pluralities of catalyst nanoparticles includes implementing first and second photo-deposition procedures to direct the first and second pluralities of catalyst nanoparticles to the water-oxidizing anode side and the proton-reducing cathode side of each nanostructure of the array of nanostructures, respectively.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 is a schematic view of a photocatalytic system having a device with a non-planar substrate surface in accordance with one example.

FIG. 2 is a flow diagram of a method of fabricating of a photocatalytic device in accordance with one example.

FIG. 3 is a diagrammatic view of energy band edge positions for examples of semiconductor materials relative to the water redox reaction.

FIG. 4 is a schematic, cross-sectional view of a photocatalytic device having a device with a non-planar substrate surface for photocatalytic water splitting in accordance with one example.

FIG. 5 is a schematic view of a nanowire of a photocatalytic device in which a layered semiconductor arrangement establishes a quadruple band structure in accordance with one example.

FIG. 6 is a schematic, perspective view of a nanowire of a photocatalytic device having a layered semiconductor arrangement and a lateral doping gradient in accordance with one example.

FIG. 7 depicts a schematic, perspective view of a nanowire of a photocatalytic device having a lateral doping gradient and selectively deposited co-catalysts for photocatalytic water splitting in accordance with one example, along with a graphical view of an energy band diagram of the nanowire.

FIG. 8 depicts photographic, plan views of examples of arrays of nanowires on planar and nonplanar substrates.

FIG. 9 is a graphical plot of normalized photoluminescence for a number of semiconductor layers of a nanowire with varying indium composition levels in accordance with one example.

FIG. 10 depicts graphical plots of hydrogen gas production as a function of dopant cell temperature in accordance with several examples of photocatalytic devices having a nonplanar substrate surface relative to the hydrogen gas production from samples having a planar substrate surface.

FIG. 11 depicts plan views of scanning electron microscope (SEM) images of an array of nanowires grown on a nonplanar substrate surface in accordance with one example, along with a dark-filed scanning transmission electron microscope (DF-STEM) image of a quadruple-band InGaN nanowire in accordance with one example, as well as graphical plots of energy-dispersive X-ray spectroscopy (EDX) line scanning showing the variation of Ga Lα, In Lα, and N Kα characteristic signals along several axial and lateral directions noted in the DF-STEM image.

FIG. 12 depicts atomic resolution STEM images of semiconductor crystal structures in accordance with several examples of varying indium composition.

FIG. 13 is a schematic view of a nanowire during a photocatalytic water splitting operation, in which a layered semiconductor arrangement establishes a quadruple band structure, and respective co-catalyst nanoparticles are disposed on cathodic and anodic surfaces of the nanowire, in accordance with one example.

FIG. 14 depicts graphical plots of normalized photoluminescence, and gas production over time, of a device having an array of quadruple band nanowires in accordance with one example.

The embodiments of the disclosed devices, systems, and methods may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Photocatalytic systems and devices for photocatalytic water splitting and other chemical reactions are described. The water splitting and other chemical reactions may be solar driven (e.g., solar water splitting). The photocatalytic systems and devices may thus be considered to implement artificial photosynthesis in some cases. The photocatalytic systems and devices include an array of conductive projections, such as nanowires or other nanostructures. Each nanostructure or other conductive projection is configured to establish a photochemical diode. Each nanostructure or other conductive projection may establish a structure to support and otherwise provide a catalyst arrangement (e.g., a co-catalyst arrangement) for the water splitting or other chemical reaction. As described herein, one or more aspects of the nanostructures or other conductive projections are directed to the efficient separation and extraction of charge carriers for the chemical reaction. Methods of fabricating the photocatalytic devices are also described herein.

A doping gradient may be introduced or incorporated into the photochemical diode structure. In some cases, a doping gradient is introduced along the lateral dimension of the nanowires. The doping gradient forms a built-in electric field, which promotes efficient charge carrier separation and extraction upon photoexcitation for, e.g., the water redox reactions in the water splitting. For these and other reasons, the quadruple-band InGaN nanowire photocatalyst devices described herein are capable of exhibiting a solar-to-hydrogen efficiency of about 5.2% with relatively stable operation. The built-in electric field and the resulting charge carrier separation also leads to well-defined cathode and anode surfaces on the nanostructures.

The nanostructures may project outward from a nonplanar surface of a substrate. As a result, the nanostructures are oriented at different angles. The orientations of the nanostructures may be useful in several respects. For instance, the orientations of the nanostructures may cause each nanostructure to have a dopant gradient that improves the performance of the photochemical diode. In some cases, each nanostructure is configured to establish a quadruple band structure. Methods of fabricating devices with such nonplanar substrate surfaces and differently oriented nanostructures are also described.

The incorporation of a nonplanar wafer or other substrate in the disclosed systems and devices is useful in other ways. For instance, the nonplanar nature of the substrate leads to enhanced light trapping and absorption. The nonplanar substrate surface also allows for incident light (e.g., sunlight) normal to the substrate to directly illuminate lateral surfaces of the nanowires or other conductive projections. The nonplanar surface also allows a greater number of nanowires to be formed on the substrate.

Photocatalytic water splitting provided by the disclosed devices and systems may involve solar-to-hydrogen conversion. The disclosed devices and systems provide improvements in the efficiency of photocatalytic water splitting. The disclosed devices and systems may include multi-band (e.g., quadruple-band) for artificial photosynthesis and solar fuel conversion with significantly improved performance. For instance, the disclosed devices and systems may include InGaN nanowire arrays to improve the efficiency of the conversion. For example, each nanowire may include layers or segments of different semiconductor compositions, such as In_{0.35}Ga_{0.65}N, In_{0.27}Ga_{0.73}N, In_{0.20}Ga_{0.80}N, and GaN, which present energy bandgaps about 2.1 eV, 2.4 eV, 2.6 eV, and 3.4 eV, respectively. As described herein, such multi-band InGaN and other nanowire arrays are integrated directly on a nonplanar wafer for enhanced light absorption.

The configuration of the multi-band nanostructure arrays may vary. In some cases, the arrays include monolithically integrated quadruple-band InGaN nanostructures configured to act as photocatalysts. Each nanostructure may include Mg-doped (p-type) In_{0.35}Ga_{0.65}N (E_{g} of about 2.1 eV), In_{0.27}Ga_{0.73}N (E_{g} of about 2.4 eV), In_{0.20}Ga_{0.80}N (E_{g} of about 2.6 eV) and GaN (E_{g} of about 3.4 eV) segments. Each nanostructure may thus be capable of absorbing a wide range of the solar spectra, including, for instance, ultraviolet and visible portions of the solar spectra.

In some cases, each nanostructure is grown on a nonplanar substrate, such as a silicon wafer. The growth process may include plasma-assisted molecular beam epitaxy (MBE). The use of a nonplanar wafer or other substrate allows for the controlled formation of a dopant gradient (e.g., an Mg doping gradient) along the lateral dimension of each nanostructure. The resulting built-in electric field steers photo-generated electrons and holes to the proton reduction and water oxidation sites or sides of the nanostructure, respectively, thereby leading to more efficient charge carrier separation and suppressed the recombination and back reaction. An STH conversion efficiency of about 5.2% was achieved by one example of a quadruple-band InGaN nanowire photocatalyst device. The artificial photosynthesis devices disclosed herein may thus achieve high efficiency, scalable solar-to-fuel conversion, including solar water splitting and reduction of carbon dioxide (CO₂) to hydrocarbon fuels.

Although described in connection with photocatalytic water splitting, the disclosed photocatalytic devices and systems may be used in other chemical reaction contexts and applications. For instance, the disclosed photocatalytic devices and systems may be useful in connection with nitrogen reduction to ammonia, CO₂ reduction to various fuels and other chemicals, and activation of C—H bonds for the production of various chemicals.

Although described herein in connection with electrodes having GaN-based nanowire arrays for water splitting, the disclosed devices and systems are not limited to GaN-based nanowire arrays. A wide variety of other types of nanostructures and other conductive projections may be used. Thus, the nature, construction, configuration, characteristics, shape, and other aspects of the conductive projections through which the water splitting is implemented may vary.

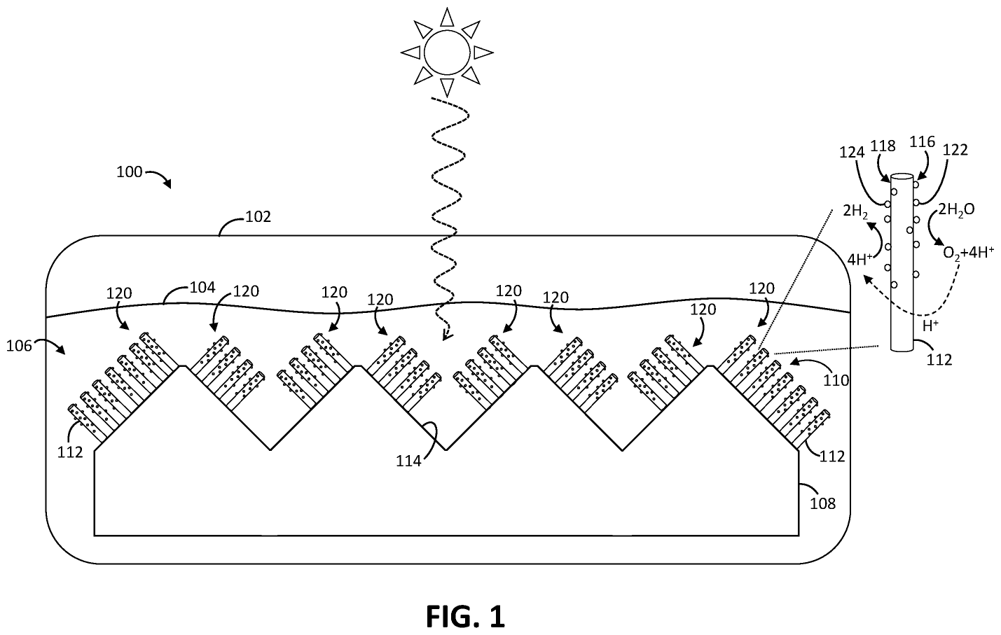

FIG. 1 depicts a photocatalytic system 100 for photocatalytic water splitting and other chemical reactions. In this example, the photocatalytic system 100 includes a container 102 in which water 104 is disposed. The water 104 may or may not be pure water. The pH of the water 104 may vary accordingly. The container 102 may be configured to allow illumination of the water 104, such as solar illumination. The size, construction, composition, configuration, and other characteristics of the container 102 may vary. The system 100 may not include a container in other cases.

The photocatalytic system 100 includes a photocatalytic semiconductor device 106 immersed in the water 104. In the example of FIG. 1, the photocatalytic semiconductor device 106 is disposed in the container 102 in a manner to allow the incident light to illuminate the semiconductor device 106. In some cases, the photocatalytic semiconductor device 106 may be configured for photocatalytic water splitting in response to the illumination.

The semiconductor device 106 includes a substrate 108 and an array 110 of conductive projections 112 supported by the substrate 108. In some cases, each conductive projection 112 is or includes a nanowire or other nanostructure. In this example, each conductive structure 112 is or includes a cylindrically shaped nanostructure. The cylindrical shape has a circular cross-sectional shape (e.g., a circular cylinder), as opposed to, for instance, a plate-shaped or sheet-shaped nanostructure. The conductive projections 112 may thus be configured, and/or referred to herein, as nanowires. The nanowires 112 extend outward from a surface 114 of the substrate 108.

The substrate 108 may be active (e.g., functional) and/or passive (e.g., structural). In one example of the former case, the substrate 108 may be or include a reflective material or layer to direct light back toward the nanowires 112. In one example of the latter case, the substrate 108 may be configured and act solely as a support structure for the nanowires 112. Alternatively or additionally, the substrate 108 may be composed of, or otherwise include, a material suitable for the growth or other deposition of the nanowires 112.

The substrate 108 may include a light absorbing material. In such cases, the light absorbing material is configured to generate charge carriers upon solar or other illumination. The light absorbing material has a bandgap such that incident light generates charge carriers (electron-hole pairs) within the substrate. Some or all of the substrate 108 may be configured for photogeneration of electron-hole pairs.

The substrate 108 may include a semiconductor material. In some cases, the substrate 108 is composed of, or otherwise includes, silicon. For instance, the substrate 108 may be provided as a silicon wafer. The silicon may or may not be doped. The doping arrangement may vary. For example, one or more components of the substrate 108 may be non-doped (intrinsic), or effectively non-doped. The substrate 108 may include alternative or additional layers, including, for instance, support or other structural layers. The composition of the substrate 108 may thus vary. For example, the substrate may be composed of, or otherwise include, metal films, GaAs, GaN, or SiOₓ in other cases.

The substrate 108 may establish a surface, e.g., the surface 114, at which a catalyst arrangement (e.g., a photocatalyst arrangement) of the semiconductor device 106 is provided. The photocatalyst arrangement is provided by the nanowires 112 of the array 110. In some cases, the catalyst arrangement may be a co-catalyst arrangement including a nanowire-nanoparticle architecture, as described below.

Each nanowire 112 has a semiconductor composition for photocatalytic water splitting. The semiconductor composition establishes a photochemical diode. In some cases, the semiconductor composition includes III-nitride semiconductor materials, such as gallium nitride (GaN) and/or one or more alloys of indium gallium nitride (InGaN). Additional or alternative semiconductor materials may be used, including, for instance, indium nitride, indium gallium nitride, aluminum nitride, boron nitride, aluminum oxide, and silicon, gallium phosphide, gallium arsenide, indium phosphide, tantalum nitride, silicon, and other semiconductor materials.

Each nanowire 112 may be or include a columnar, rod-shaped, post-shaped, or other elongated structure. The nanowires 112 may be grown or formed as described in U.S. Pat. No. 8,563,395 (“Method of growing uniform semiconductor nanowires without foreign metal catalyst and devices thereof”), the entire disclosure of which is hereby incorporated by reference. The dimensions (e.g., length, diameter), size, shape, and other characteristics of the nanowires 112 may vary.

The semiconductor composition of each nanowire 112 establishes a photochemical diode. As described herein, each nanowire 112 may be configured to have an anode side or surface 116 and a cathode side or surface 118. The anode and cathode sides 116, 118 may be parallel, opposing sides of the nanostructure, as shown. A photochemical diode may be established between the anode and cathode sides 116, 118 of a single one of the nanowires 112. As described herein, the water oxidation reaction (2H₂O—>O₂+4H⁺+4e⁻) of the water splitting occurs along the anode side 116. The proton reduction reaction (4H⁺+4e⁻->2H₂) of the water splitting occurs at the cathode side 118. Proton diffusion from the water oxidation reaction to the proton reduction reaction may occur across a single one of the nanowires 112. Alternatively or additionally, the proton diffusion may occur between two adjacent nanowires 112 in the array 110. As described herein, the configuration of the array 110 may be useful for promoting water splitting involving a pair of the nanowires 112 due to the proximity of the anode and cathode sides 116, 118 of the pair.

Each nanowire 112 extends outward from the surface 114 of the substrate 108. In this example, the surface 114 of the substrate 108 is nonplanar such that subsets 120 of the array 110 are oriented at different angles. As shown in FIG. 1, the nanowires 112 in each subset 120 may be oriented in parallel with one another.

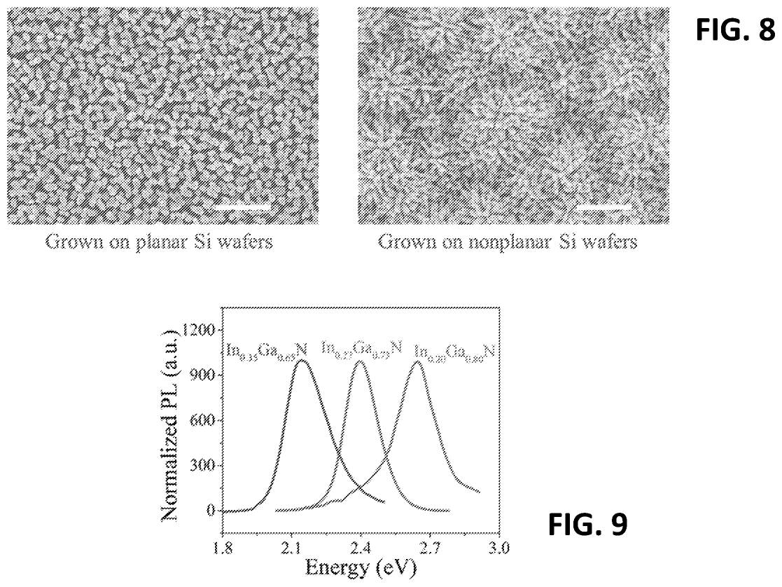

In the example of FIG. 1, the surface 114 is a multi-faceted surface. Each subset 120 of the array 110 extends outward from a respective face of the surface 114. The faces of the surface 114 may be defined in accordance with the manner in which the device 106 is fabricated. For example, if the substrate 108 is or includes a silicon wafer of <100> orientation, a wet etch procedure may result in a pyramidal textured surface. In such cases, the pyramids of the surface 114 are square-based pyramids with four sides defined by the <111> crystallographic planes. Each subset 120 of the array 110 extends outward from a respective face of each pyramid. Examples of the subsets 120 of a nanowire array 110 projecting outward from the facets or faces of a pyramidal or other textured surface are shown and described in connection with FIGS. 4 and 8.

The manner in, or degree to, which the surface 114 is multi-faceted or otherwise nonplanar may vary. For instance, the surface 114 may have any number of faces oriented at any angle. The pyramids or other shapes along the surface 114 may be uniform or non-uniform. For example, an etch procedure used to define the surface 114 may etch the substrate 108 at different rates in different locations. The nonplanarity of the surface 114 may vary in accordance with the manner in which the surface 114 is defined or formed. For example, a mold may be used to define a profile or contour for the surface 114. In these and other ways, any desired morphology may thus be achieved.

The nanowires 112 may be configured to generate electron-hole pairs upon illumination. The nanowires 112 may be configured to generate the electron-hole pairs upon absorption of light at certain wavelengths. In some cases, each nanowire 112 may be configured to absorb light over a wide range of wavelengths and, thus, improve the efficiency of the photocatalytic water splitting. For instance, each nanowire 112 may include a layered arrangement of semiconductor materials. Each layer in the arrangement may be configured for absorption of light of different wavelengths.

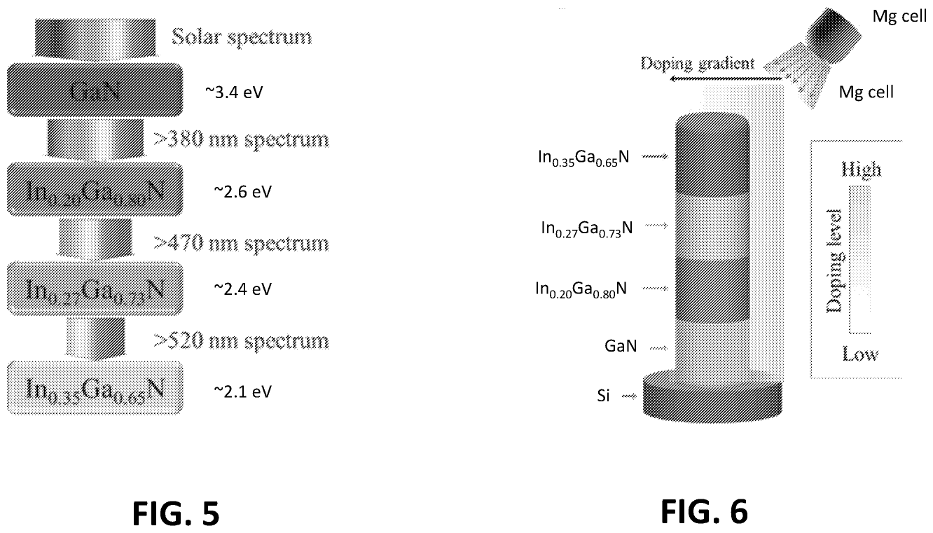

The layered arrangement of semiconductor materials is used to establish a multi-band structure, such as a quadruple band structure. Each layer or segment of the arrangement may have a different semiconductor composition to establish a different bandgap. For instance, in III-nitride examples, the layers or segments of the arrangement may have different indium and gallium compositions. Examples of layered arrangements configured to provide a quadruple band structure are shown and described in connection with FIGS. 5, 6, and 13.

The layered arrangement of the nanowires 112 may vary from the examples described herein. For example, further details regarding the formation and configuration of multi-band structures, including, for instance, triple-band structures, are provided in U.S. Pat. No. 9,112,085 (“High efficiency broadband semiconductor nanowire devices”) and U.S. Pat. No. 9,240,516 (“High efficiency broadband semiconductor nanowire devices”), the entire disclosures of which are incorporated by reference.

The semiconductor composition of each nanowire 112 may be configured to improve the efficiency of the water splitting in additional ways. For instance, in some cases, the semiconductor composition of each nanowire 112 may include doping to promote charge carrier separation and extraction, as well as to facilitate the establishment of a photochemical diode (e.g., to promote charge carrier separation and extraction). For example, a dopant concentration of the semiconductor composition may vary laterally and/or from layer to layer. In the example of FIG. 1, the dopant concentration decreases from the anode side 116 to the cathode side 118 to establish a lateral dopant gradient.

The dopant gradient may be formed during fabrication as a result of the angled orientation of the nanowires 112. As shown in FIG. 1, the anode side 116 faces away from the substrate 108, and thus toward a dopant source. In contrast, the cathode side 118 faces toward the substrate 108, and thus away from the dopant source. The anode sides 116 of the nanowires 112 are consequently more heavily doped.

In examples involving III-nitride compositions, the dopant may be or include magnesium. Further details regarding the manner in which magnesium doping promotes charge carrier separation and extraction are set forth in U.S. Pat. No. 10,576,447 (“Methods and systems relating to photochemical water splitting ”), the entire disclosure of which is incorporated by reference. Additional or alternative dopant materials may be used, including, for instance, silicon, carbon, zinc, and beryllium, depending on the semiconductor light absorber of choice.

The semiconductor device 106 may further include one or more types of catalyst nanoparticles 122, 124 disposed over the array 110 of nanowires 112. Pluralities of each type of the nanoparticles 122, 124 are disposed on each nanowire 112, as schematically shown in FIG. 1. The nanoparticles 122, 124 are distributed across or along the outer surface (e.g., sidewalls) of each nanowire 112. In the example of FIG. 1, one type of nanoparticle 122 is disposed on the anode side 116 of each nanowire 112, and another type of nanoparticle 124 is disposed on the cathode side 118 of each nanowire 112. The nanoparticles 122 are configured to facilitate or promote the water-oxidation reaction. The nanoparticles 124 are configured to facilitate or promote the proton reduction reaction. Further details regarding the formation, configuration, functionality, and other characteristics of nanoparticles in conjunction with a nanowire array are set forth in one or more of the above-referenced U.S. patents.

In some cases, the nanoparticles 122 on the water-oxidizing anode side 116 are composed of, or otherwise include, cobalt oxide. The nanoparticles 124 on the proton-reducing cathode side may be composed of, or otherwise include, rhodium (Rh). For example, the Rh-based nanoparticles may have a core-shell configuration in which a Rh core is surrounded by a shell, such as a shell composed of, or otherwise including, chromium oxide (Cr₂O₃). However, additional or alternative materials may be used, including, for instance, iridium oxide, copper oxide, and nickel oxide for water oxidation, and platinum, gold, nickel, palladium, iron, and copper for proton reduction.

The nanoparticles 122, 124 may be sized in a manner to facilitate the water splitting. The size of the nanoparticles 122, 124 may be useful in catalyzing the reaction, as described herein. The size of the nanoparticles 122, 124 may promote the water splitting in additional or alternative ways. For instance, the nanoparticles 122, 124 may also be sized to avoid inhibiting the illumination of the nanowires 112.

The distribution of the nanoparticles 122, 124 may be uniform or non-uniform. The nanoparticles 122, 124 may thus be distributed randomly across each nanowire 112. The schematic arrangement of FIG. 1 is shown for ease in illustration.

The nanowires 112 and the nanoparticles 122, 124 are not shown to scale in the schematic depiction of FIG. 1. The shape of the nanowires 112 and the nanoparticles 122, 124 may also vary from the example shown. Further details regarding the nanowire-nanoparticle co-catalyst arrangement, including the fabrication thereof, are provided below.

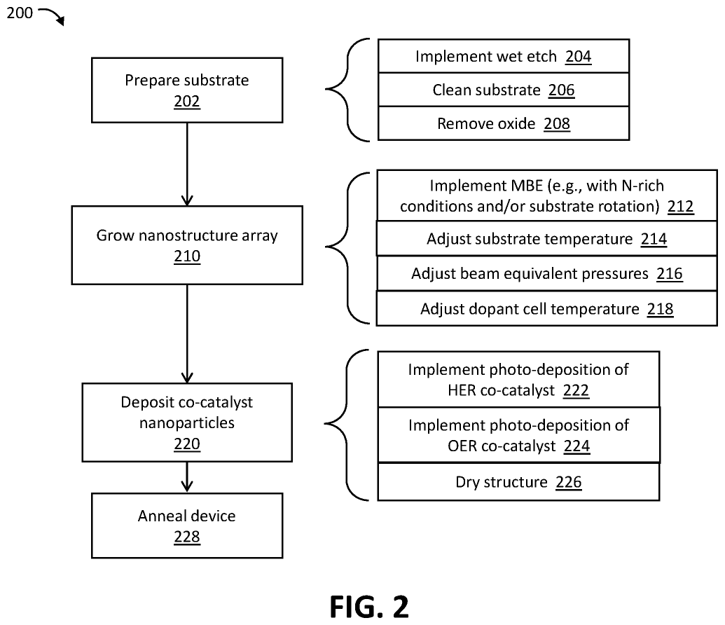

The nanoparticle-nanowire co-catalyst arrangement may be fabricated on a substrate (e.g., a silicon substrate) via nanostructure-engineering. In one example, molecular beam epitaxial (MBE) growth of the nanowires is followed by photo-deposition of the nanoparticles. The photo-deposition of the nanoparticles may be configured to selectively deposit the nanoparticles on the respective sides of the nanowire. Further details regarding example fabrication procedures are provided below, e.g., in connection with FIG. 2.

The nanowires 112 may facilitate the water splitting in alternative or additional ways. For instance, each nanowire 112 may be configured to extract charge carriers (e.g., electrons) generated in the substrate 108 (e.g., as a result of light absorbed by the substrate 108). In such cases, the opposite side of the substrate 108 may be configured for hole extraction. The extraction brings the charge carriers to external sites along the nanowires 112 for use in the water splitting or other reactions. For instance, the nanowires 112 may thus form an interface well-suited for reduction of CO₂, and/or other reactions.

FIG. 2 depicts a method 200 of fabricating a semiconductor device for photocatalytic water splitting in accordance with one example. The method 200 may be used to manufacture any of the devices described herein or another device. The method 200 may include additional, fewer, or alternative acts. For instance, the method 200 may or may not include one or more acts directed to annealing the device (act 228).

The method 200 may begin with an act 202 in which a substrate is prepared or otherwise provided. The substrate may be or be formed from a silicon wafer. In one example, a 2-inch Si wafer was used, but other (e.g., larger) size wafers may be used. Other semiconductors and substrates may be used.

The substrate has a nonplanar surface as described above. In some cases, the act 202 includes an act 204 in which a wet or other etch procedure is implemented to define the surface. For example, the etch procedure may be or include a crystallographic etch procedure. In silicon substrate examples, the crystallographic etch procedure may be or otherwise include a KOH etch procedure. In such cases, if the substrate has a <100> orientation, the wet etch procedure establishes that the surface includes a pyramidal textured surface with faces oriented along <111> planes, but additional or alternative facets may be present in some cases.

The act 202 may include fewer, additional, or alternative acts. For instance, in the example of FIG. 1, the act 202 includes an act 206 in which the substrate is cleaned, and an act 208 in which oxide is removed.

In one example, a prime-grade polished silicon wafer is etched in 80° C. KOH solution (e.g., 1.8% KOH in weight with 20% isopropanol in volume) for 30 minutes to form the micro-textured surface with Si pyramids. After being neutralized in concentrated hydrochloric acid, the substrate surface is cleaned by acetone and/or methanol, and native oxide is removed by 10% hydrofluoric acid.

The method 200 includes an act 210 in which a nanowire or other nanostructure array is grown or otherwise formed on the substrate. Each nanowire is formed on the surface of the substrate such that each nanostructure extends outward from the surface of the substrate. Each nanostructure has a semiconductor composition, as described herein. The nanostructure growth may be achieved in an act 212 in which molecular beam epitaxy (MBE) is implemented. The MBE procedure may be implemented under nitrogen-rich conditions. Alternatively or additionally, the substrate may be rotated during the MBE procedure such that each nanostructure is shaped as a cylindrically shaped nanostructure. Each nanostructure may thus have a circular cross-sectional shape, as opposed to a plate-shaped or sheet-shaped nanostructure.

In some cases, the MBE procedure may be modified to fabricate the arrangement of layers or segments of each nanowire directed to providing a multi-band structure. Various parameters may be adjusted to achieve the different composition levels of the layers. For instance, the substrate temperature may be adjusted in an act 214. Beam equivalent pressures may be adjusted in an act 216. In some cases, a dopant cell temperature is adjusted to control the doping (e.g., Mg doping) of the nanowires.

In one example, Mg-doped InGaN nanowires were grown by plasma-assisted molecular beam epitaxy (MBE) under N-rich conditions. The growth parameters included a gallium (Ga) beam equivalent pressure of about 7E-8 Torr, a nitrogen flow rate of 1 sccm, and a plasma power of 350 W. The substrate temperature, indium (In) beam equivalent pressure (BEP), and magnesium (Mg) cell temperature were tuned to synthesize different single-band or multi-band InGaN nanowires with various p-doping and alloy concentrations. For instance, for single-band p-GaN nanowires or a GaN layer of a multi-band structure, the substrate temperature was 685° C., and Ga BEP was about 7E-8 Torr. The p-type doping level was tuned by using different Mg cell temperatures. For a p-In_{0.20}Ga_{0.80}N nanowire layer, the substrate temperature was 675° C., the Ga BEP was about 7E-8 Torr, and the In BEP was about 7.3E-8. For p-In_{0.27}Ga_{0.73}N nanowire layers, the substrate temperature was 662° C., the Ga BEP was about 7E-8 Torr, and the In BEP was about 7.3E-8. For p-In_{0.35}Ga_{0.65}N nanowire layers, the substrate temperature was 640° C., the Ga BEP was about 7E-8 Torr, and the In BEP was about 3.5E-8. For quadruple-band InGaN nanowires, the growth conditions are similar to those of the constituting single-band nanowires but with varying thicknesses for each segment. The substrate temperature may refer to a thermocouple reading of a substrate heater, which may be different from the actual substrate surface temperature, which may depend on the sample size, substrate holder, and mounting configuration.

In the example of FIG. 2, the method 200 further includes an act 220 in which one or more types of catalyst nanoparticles are deposited across the array of nanowires. As described above, in some cases, two types of catalyst nanoparticles are deposited. One type of catalyst nanoparticle may be deposited on a water-oxidizing anode side of each nanowire. Another type of nanoparticle may be deposited on a proton-reducing cathode side of each nanowire.

The selective deposition of the nanoparticles may be achieved via implementation of two photo-deposition procedures. In the example of FIG. 2, the act 220 includes an act 222 in which hydrogen evolution reaction (HER) co-catalyst nanoparticles are deposited on the proton reducing cathode sides, and an act 224 in which oxygen evolution reaction (OER) co-catalyst nanoparticles are deposited on the water oxidizing anode sides. The photo-deposition procedures are configured to direct the catalyst nanoparticles to the respective sides, as described herein. Further details regarding the photo-deposition procedures are set forth in one or more of the above-referenced U.S. patents.

In one example, the co-catalyst nanoparticles were deposited using a photo-deposition procedure in which an InGaN nanowire device was put in a glass chamber with a quartz lid. The chamber was pumped down and then illuminated using a 300 W Xenon lamp for 20 minutes to deposit cocatalyst nanoparticles on the InGaN nanowires. The deposition of Rh/CrOₓ core/shell structures included two steps. The first step involved the use of 55 ml deionized water, 11 mL methanol, and 2 μmol sodium hexachlororhodate (Na₃RhCl₆) for the formation of the Rh core. The second step involved the use of 55 mL deionized water, 11 mL methanol, and 4 μmol potassium chromate (K₂CrO₄) to form the CrOₓ shell. The deposition of CoOₓ nanoparticles included the use of 60 mL deionized water, 6 mL potassium iodate (KIO₃, 0.01 M), and 4 μmol cobalt nitrate (Co(NO₃)₂). The deposition time, volume of water, volume of methanol, precursors, and/or other characteristics may vary depending on the sample area and nanowire growth duration or size.

The method 200 may include one or more additional acts directed to forming the photocatalytic structures of the device. For instance, in some cases, the method 200 includes an act 228 in which the photocatalytic structures of the device are annealed. The parameters of the anneal process may vary.

The order of the above-described acts of the method 200 may differ from the example shown. For instance, the annealing of the act 228 may be implemented before or after the deposition of the nanoparticles in the act 220.

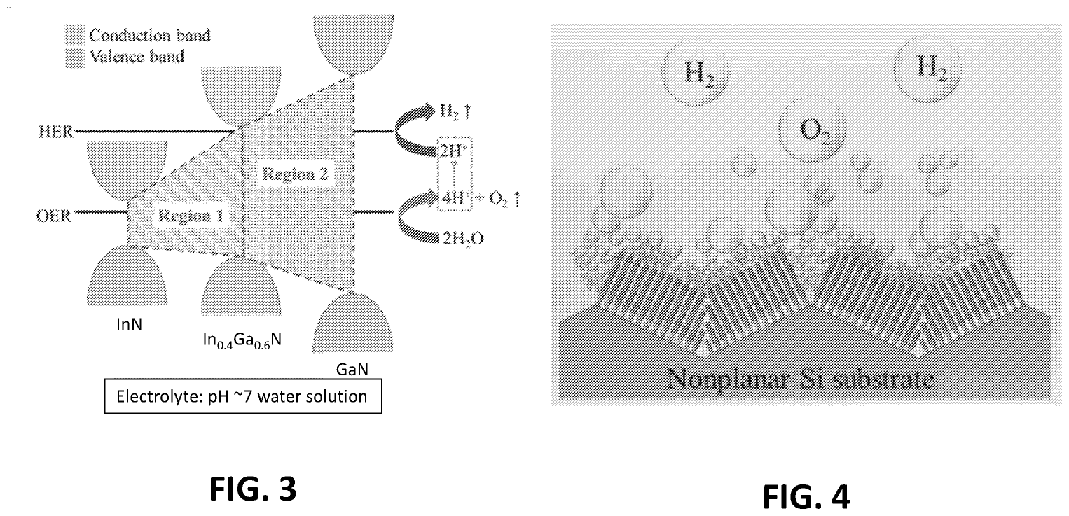

Details regarding examples of the above-described devices, systems, and methods are now provided in connection with FIGS. 3-14.

FIG. 3 schematically illustrates the conduction and valence band edge positions of example semiconductor compositions for the nanostructures of the disclosed methods and systems. In this case, the conduction and valence band edge positions of GaN, In_{0.4}Ga_{0.6}N, and InN, and their respective alignments are shown relative to the water redox potentials, represented by the hydrogen evolution reaction (HER) and the oxygen evolution reaction (OER) in a pH neutral water solution. As shown in FIG. 3, InGaN alloys with indium compositions up to about 40% are capable of meeting the stringent electronic and thermodynamic requirements for overall water splitting. Such InGaN alloys may therefore be used to drive solar water splitting in pH neutral electrolyte solutions without sacrificial reagents.

FIG. 4 schematically depicts a photocatalytic water splitting system in accordance with one example. In this case, the system includes a nonplanar silicon wafer. FIG. 4 also shows an example of the monolithic integration of InGaN nanowire arrays on a nonplanar silicon wafer or other substrate.

FIG. 5 shows a layered arrangement or configuration of a quadruple-band InGaN nanowire or other conductive projection in accordance with one example. The nanowire structure is depicted along with a light splitting diagram to illustrate the absorption across the solar spectrum. In this example, the indium compositions in each band are 0%, about 20%, about 27%, and about 35%, which correspond to energy bandgaps of about 3.4 eV, about 2.6 eV, about 2.4 eV, and about 2.1 eV, respectively. Together the four bandgaps are capable of absorbing solar photons with wavelengths up to about 600 nm. For comparison, previously reported photocatalytic devices have absorbed high energy photons (e.g., 2.8-3.5 eV) for overall water splitting, thereby limiting the realized energy conversion efficiency.

As shown in the example of FIG. 5, the nanowire configuration has an inverted multi-band structure. The configuration is inverted in the sense that the layer with the largest bandgap, and corresponding least light absorption, is disposed or placed atop the structure. The layer with the largest bandgap is thus farthest from the substrate. The other layers are then arranged such that the size of the bandgaps decreases as the distance from the substrate decreases.

FIG. 6 schematically shows a monolithically integrated quadruple-band In_{0.35}Ga_{0.65}N/In_{0.27}Ga_{0.73}N/In_{0.20}Ga_{0.80}N/GaN nanowire structure for the photocatalytic water splitting of the disclosed devices and systems in accordance with one example. The nanowire includes a stacking sequence or layered arrangement. The layers of the arrangement may be grown by plasma-assisted MBE, as described herein.

FIG. 6 also depicts how only one side of the nanowires is directly exposed to the doping flux (e.g., Mg doping flux) during nanowire epitaxial growth. Only one side is directly exposed to the flux as a result of the nonplanar surfaces of the Si wafer or other substrate, as well as the formation and projection of the nanowires outward from each facet or other portion of the surface (see, e.g., FIG. 4). As a result, the doping gradient (e.g., an Mg doping gradient) is established or formed along the lateral dimension of each nanowire. The doping gradient, in turn, introduces a built-in electric field within each nanowire.

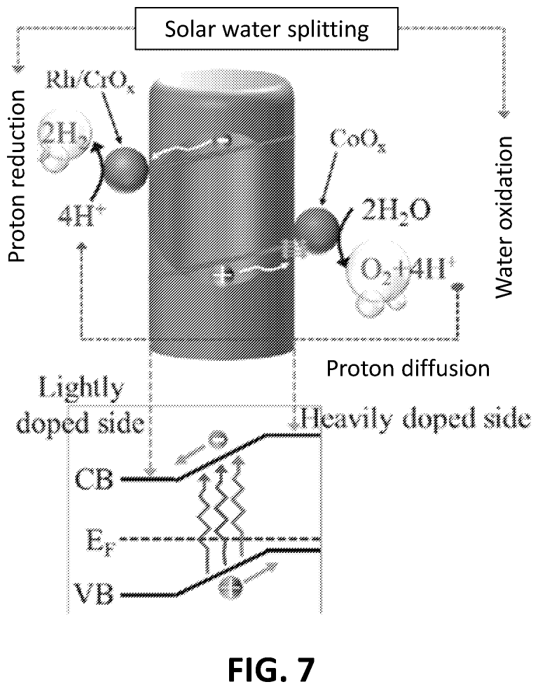

FIG. 7 schematically illustrates the built-in electric field provided by the configuration of the nanowires in accordance with one example. FIG. 7 shows that photo-generated electrons migrate towards the lightly doped (e.g., Mg-doped) side for the proton reduction reaction, whereas photo-generated holes drift to the more heavily doped (e.g., Mg-doped) surface for the water oxidation reaction. The rapid separation and extraction of photo-generated electrons and holes to the respective cathodic and anodic sides or surfaces may significantly reduce charge carrier recombination and further suppress any back reaction, thereby leading to enhanced efficiency for solar water splitting.

FIG. 8 depicts scanning electron microscope (SEM) images of metal-nitride (e.g., InGaN) nanowires grown on planar and nonplanar Si wafers. In one example, the InGaN nanowires grown on the nonplanar Si wafer exhibited a relative increase in hydrophilic behavior. Such an increase may promote more efficient mass diffusion during solar water splitting.

FIG. 9 depicts the photoluminescence (PL) emission spectra of single-band InGaN nanowires. The PL emission spectra of several examples of single-band InGaN nanowires with various indium compositions were measured at room temperature. The PL data confirms the excellent material quality of the nanowire examples. By varying the growth conditions (as described herein), the energy bandgaps of the nanowires may be tuned to present bandgaps from about 3.4 eV to about 2.1 eV, which correspond to PL emission wavelengths from about 370 nm to about 580 nm, respectively. For the PL emission at about 580 nm, the corresponding indium composition is about 35%.

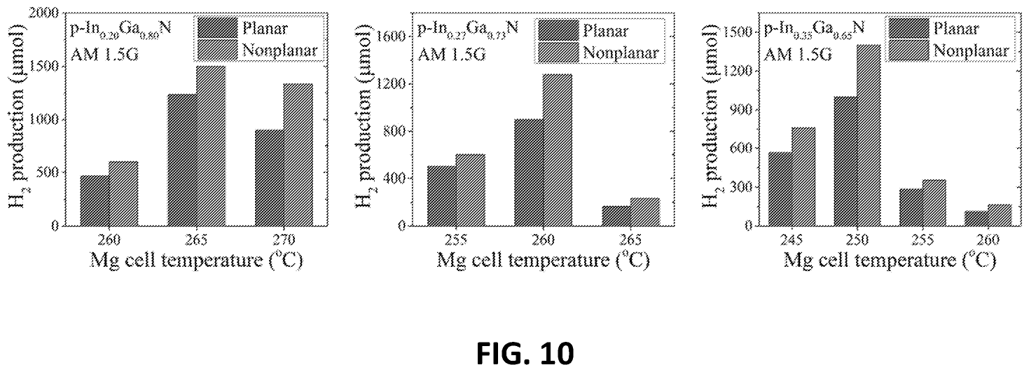

FIG. 10 depicts the results of photocatalytic water splitting tests conducted on individual single-band InGaN nanowire photocatalysts with varied indium compositions and Mg-dopant incorporations. The photocatalytic water splitting performance of p-In_{0.20}Ga_{0.80}N, p-In_{0.27}Ga_{0.73}N, and p-In_{0.35}Ga_{0.65}N, respectively, is summarized in the plots of FIG. 10. The devices had areal sizes of about 2.5-3 cm², which were used to optimize the doping condition. The Mg doping may be useful in improving the photocatalytic performance of III-nitride materials for overall solar water splitting. The effect of Mg doping on solar hydrogen gas production may be analyzed and optimized by varying the Mg doping flux, which is controlled by the Mg effusion cell temperature. In one example, the optimum Mg cell temperatures were identified to be about 265° C., 260° C., and 250° C. for In_{0.20}Ga_{0.80}N, In_{0.27}Ga_{0.73}N, and In_{0.35}Ga_{0.65}N nanowire photocatalysts, respectively.

The Mg dopant concentration may be used to minimize or otherwise reduce the surface band bending for the efficient extraction of photo-generated charge carriers. The optimum Mg doping levels may depend on indium composition and growth conditions, as described herein. Moreover, as shown in FIG. 10, a 20-40% increase in hydrogen production rate was realized for InGaN photocatalysts grown on nonplanar Si wafers compared to those on planar Si wafers under optimized conditions, due to, in part, the enhanced charge carrier separation and extraction (see, e.g., FIG. 7).

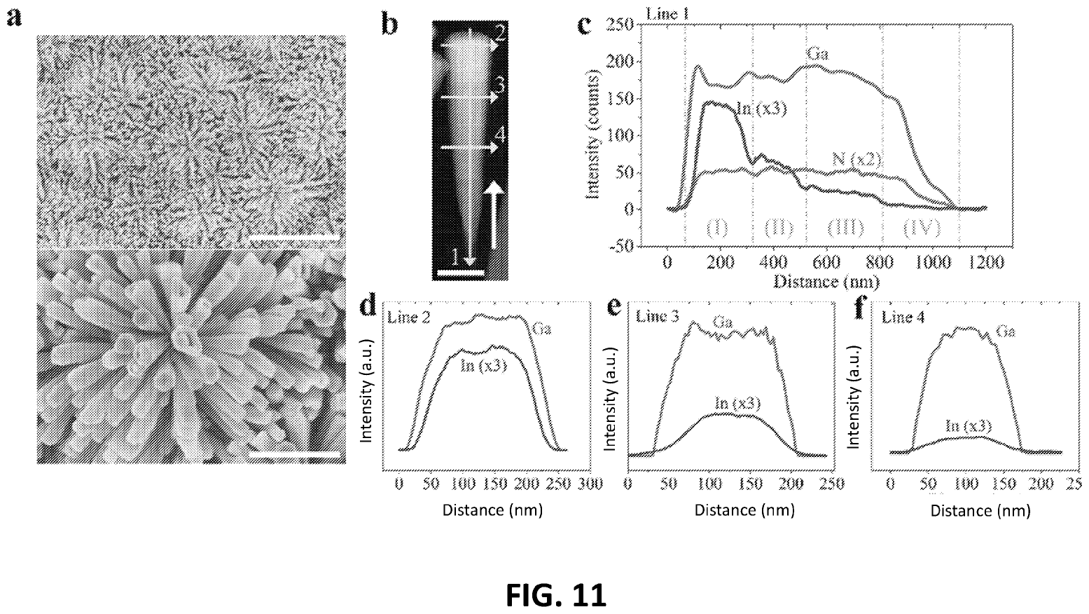

FIG. 11 depicts the results of further testing of examples of quadruple-band metal-nitride nanowire photocatalyst structures. In these examples, layers of p-In_{0.35}Ga_{0.65}N, p-In_{0.27}Ga_{0.73}N, and p-In_{0.20}Ga_{0.80}N were monolithically integrated together on a p-GaN segment (see, e.g., FIG. 6). Together, the layers are capable of absorbing incident light with wavelengths up to about 600 nm. Part (a) of FIG. 11 depicts SEM images of the quadruple-band InGaN nanowires grown on a nonplanar Si substrate. The nonplanarity of the substrate surface leads to a flower-shaped morphology of the InGaN nanostructures. Such morphology may maximize the side surface exposed to incident light illumination.

The multi-band InGaN nanowires were further characterized by scanning transmission electron microscopy (STEM) and energy-dispersive X-ray spectroscopy (EDX). Part (b) of FIG. 11 depicts the STEM images, with the brighter contrast in the top region of the nanowire indicating more indium incorporation due to the atomic number contrast nature in high angle annular dark-field (HAADF) imaging. The InGaN nanowire becomes wider in diameter along the growth direction (indicated by the arrow). The EDX line scans were performed along axial and lateral directions of the InGaN nanowire. The EDX scans were performed along the lines enumerated 1-4 in FIG. 11. Parts (c)-(f) of FIG. 11 present the variations of the Ga Lα, In Lα, and N Kα characteristic signals for the EDX scans along the lines 1-4, respectively, shown in part (b) of FIG. 11. Along the axial direction, the In Lα signal intensity gradually decreases, indicating the reduced concentration of In incorporation from top to bottom of the InGaN nanowire (see, e.g., the configuration shown in FIG. 6). There are four segments forming the quadruple-band InGaN nanowire, including (I) In_{0.35}Ga_{0.65}N, (II) In_{0.27}Ga_{0.63}N, (III) In_{0.20}Ga_{0.80}N, and (IV) GaN. For each InGaN segment, relative variations of the Ga Lα and In Lα characteristic signal along the nanowire lateral dimensions are measured and shown in parts (d)-(f) of FIG. 11, respectively.

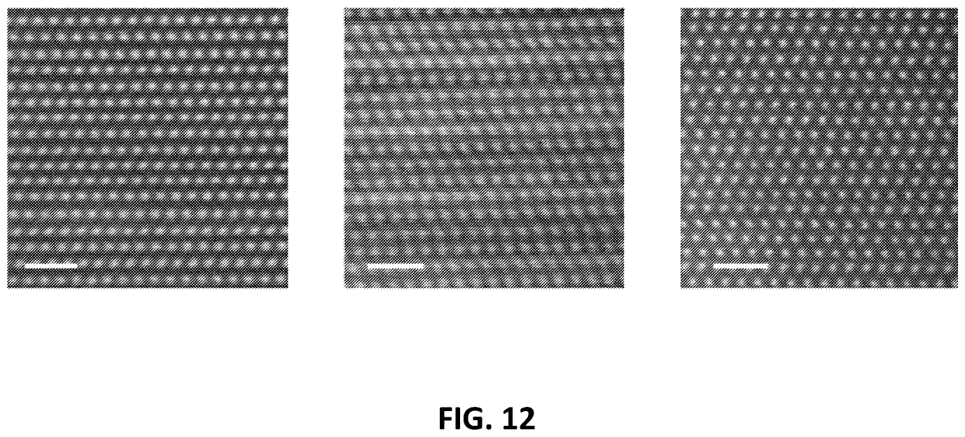

FIG. 12 depicts atomic resolution HAADF-STEM images for InGaN crystals with various indium compositions. The periodic ordering of atoms shown in FIG. 12 demonstrates the high crystallinity of the InGaN structures, which is useful to reduce bulk recombination for efficient charge carrier extraction.

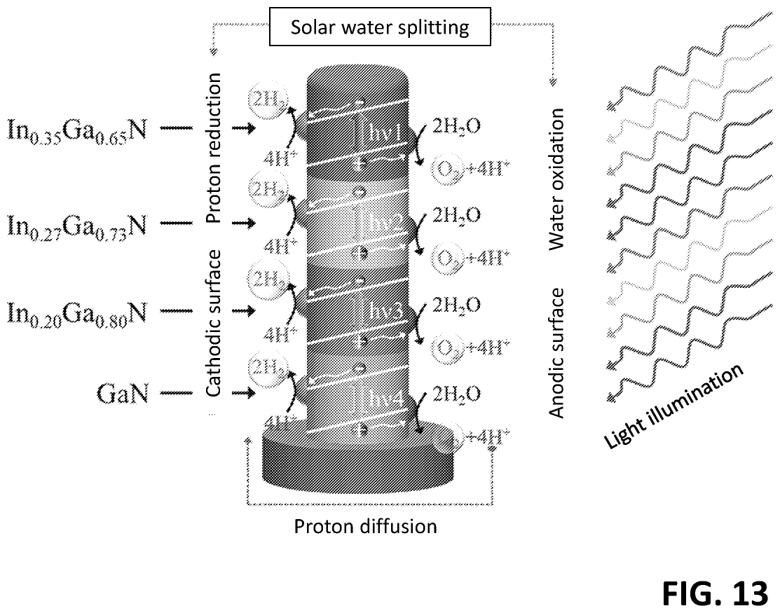

FIG. 13 schematically illustrates the overall solar water splitting process in accordance with one example. In this case, a quadruple-band InGaN nanowire photocatalyst is illuminated with light (e.g., solar light). The illumination leads to photon excitation in each single-band segment or layer, which, in turn, is followed by charge carrier separation and extraction. The extracted charge carriers are then used in the catalytic water splitting reactions. Due to the built-in electric field introduced by the doping gradient (e.g., the Mg doping gradient profile), the photo-generated electrons and holes are efficiently separated and directed toward the cathodic surface or side to drive the water reduction reaction and toward the anodic surface or side to drive the water oxidation reaction, respectively.

FIG. 13 also shows the role of the separately deposited Rh and CoOₓ co-catalyst nanoparticles. The Rh and CoOₓ co-catalyst nanoparticles are selectively deposited on the lightly and heavily doped (e.g., Mg-doped) InGaN surfaces, respectively. The selective deposition of the co-catalyst nanoparticles arises from efficient charge carrier separation and extraction due to the doping gradient (e.g., Mg doping gradient) along the lateral dimension of the nanowires. Due to doping gradient, charge carriers (holes and electrons) migrate to the opposite surfaces, leading to selective deposition of oxidation and reduction catalysts on the two surfaces. In operation, the selective deposition of the co-catalyst nanoparticles supports the rapid separation and extraction of the photo-generated electrons and holes at the respective cathodic and anodic surfaces or sides. Such separation and extraction may significantly reduce charge carrier recombination and further suppress any back reaction.

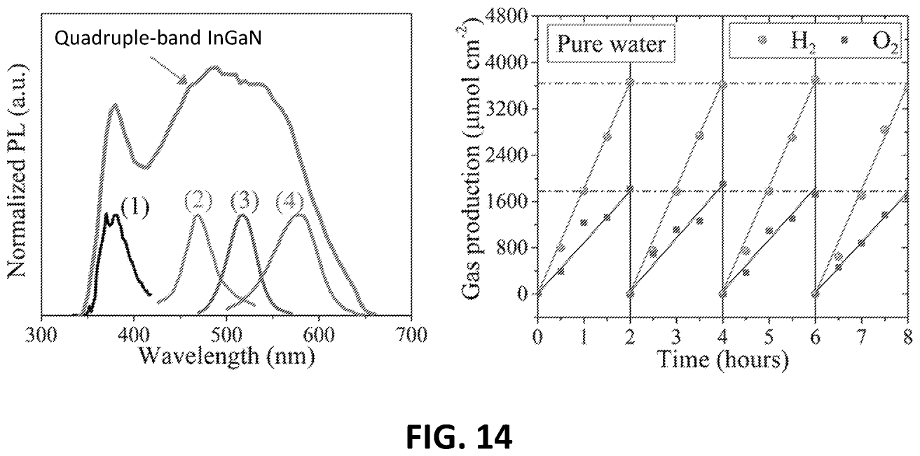

FIG. 14 depicts the PL spectrum of quadruple-band InGaN nanowires in accordance with one example. The spectrum was measured at room temperature. A broad emission spectrum was realized, which is indicative of a capability of solar photon absorption across nearly the entire visible spectrum. The PL emission spectra of individual InGaN segments (e.g., the InGaN segments shown in FIG. 6) are also plotted in FIG. 14 for comparison.

FIG. 14 also depicts the results of the photocatalytic water splitting performance of the above-referenced quadruple-band nanowire arrays in a pure water solution having a pH of about 7 under concentrated light illumination using an AM 1.5 G filter. FIG. 14 shows the H₂ and O₂ gas evolution for 120 minutes of continuous solar water splitting. Multiple cycles of photocatalytic experiments were further performed to confirm the stable, continuous gas production. The calculated H₂ to O₂ production ratio is nearly 2:1, corresponding to the stoichiometric ratio in water molecules (H₂O), which is consistent with overall water splitting reaction occurring without any other byproduct. The maximum H₂ generation rate was measured to be about 1840 μmol cm⁻² h⁻¹, which corresponds to an STH efficiency of about 5.2%.

The efficiency achieved by the disclosed devices and systems compares favorably with other photocatalyst systems for overall solar water splitting. For example, a double-band In_{0.22}Ga_{0.78}N/GaN photochemical diode has realized an STH efficiency of 3.3%. For metal oxide and other nitride semiconductors showing comparable photocatalytic stability, e.g., SrTiO₃, BiVO₄, and C₃N₄, the highest STH efficiency has generally been limited to about 1%, mainly due to insufficient light absorption and strong recombination.

An improvement in stability has also achieved. Compared to a previously reported CoOₓ particulate system with approximately 30 minutes of stability, the quadruple-band metal-nitride nanowires of the disclosed devices and systems demonstrate relatively good stability during overall solar water splitting, without showing any significant degradation of photocatalytic performance for about 8 hrs. Compared to previously reported III-nitride photocatalysts, the significantly improved performance may be attributed to the following factors: 1) the use of quadruple-band structure to enhance visible light absorption and water redox reaction, 2) the use of nonplanar wafer to enhance light absorption and trapping effect, and 3) controlled p-type dopant incorporation to enhance charge carrier separation and extraction.

Theoretically, the ideal multi-band photocatalytic system of the disclosed devices and system is potentially capable of reaching a maximum energy conversion efficiency about 16%, if all the incident photons above the energy bandgap are converted to charge carriers to drive the water splitting reactions. Therefore, such multi-band nanostructures may be further optimized to achieve a possible STH efficiency of over 10%.

Other examples of the disclosed devices and systems may realize such higher efficiencies via, for instance, (1) placement of large energy gap materials on top of the layered arrangement, (2) optimization of the deposition of co-catalyst particles, (3) integration of such nanowire photocatalysts on a reflective substrate surface to further enhance light absorption, and (4) minimization of surface recombination by surface treatment or passivation.

Described hereinabove are systems and devices having nanostructure (e.g., InGaN nanowire) photocatalysts. The photocatalysts may be fabricated at the wafer level. The photocatalysts are capable of achieving broadband performance in, as well as improvements in the efficiency of, direct photocatalytic overall water splitting. The photocatalysts may be synthesized on low cost, large area wafers (e.g., Si wafers). The method of fabrication includes a number of industry standard manufacturing procedures. Therefore, the disclosed devices and systems may be manufactured at large scales. The disclosed devices and systems may also utilize suitable co-catalysts to achieve high efficiency, stable artificial photosynthesis, including one-step CO₂ reduction to hydrocarbon fuels.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. A photocatalytic device comprising:
a substrate having a surface; and
an array of conductive projections supported by the substrate and extending outward from the surface of the substrate, each conductive projection of the array of conductive projections having a semiconductor composition, the semiconductor composition establishing a photochemical diode;
wherein the surface is nonplanar such that subsets of the array of conductive projections are oriented at different angles.

2. The photocatalytic device of claim 1, wherein the surface comprises a multi-faceted surface.

3. The photocatalytic device of claim 1, wherein the surface comprises a pyramidal textured surface.

4. The photocatalytic device of claim 1, wherein:
each conductive projection of the array of conductive projections comprises a layered arrangement of semiconductor materials; and
the layered arrangement of semiconductor materials establishes a quadruple band structure.

5. The photocatalytic device of claim 1, wherein:
each conductive structure of the array of conductive structures comprises a first side and a second side opposite the first side;
the first side faces away from the substrate;
the second side faces toward the substrate; and
a dopant concentration of the semiconductor composition decreases from the first side to the second side to establish a lateral dopant gradient.

6. The photocatalytic device of claim 1, wherein the semiconductor composition comprises indium gallium nitride doped with magnesium.

7. The photocatalytic device of claim 1, wherein each conductive projection of the array of conductive projections comprises a nanowire.

8. The photocatalytic device of claim 1, wherein the substrate comprises silicon.

9. The photocatalytic device of claim 1, further comprising first and second pluralities of catalyst nanoparticles disposed over the array of conductive projections, the catalyst nanoparticles of the first and second pluralities of catalyst nanoparticles being disposed on a water-oxidizing anode side and a proton-reducing cathode side of each conductive projection of the array of conductive projections, respectively.

10. The photocatalytic device of claim 9, wherein:
each catalyst nanoparticle of the first plurality of catalyst nanoparticles on the water-oxidizing anode side comprises cobalt oxide; and
each catalyst nanoparticle of the second plurality of catalyst nanoparticles on the proton-reducing cathode side comprises rhodium (Rh).

11. A photocatalytic system comprising:
a container in which water is disposed; and
a semiconductor device immersed in the water;
wherein the semiconductor device comprises:
a substrate having a pyramidal textured surface; and
an array of nanostructures supported by the substrate and extending outward from the pyramidal textured surface of the substrate, each nanostructure of the array of nanostructures having a semiconductor composition, the semiconductor composition establishing a photochemical diode;
wherein the pyramidal textured surface orients subsets of the array of nanostructures at different angles.

12. The photocatalytic system of claim 11, wherein:
each nanostructure of the array of nanostructures comprises a layered arrangement of semiconductor materials; and
the layered arrangement of semiconductor materials establishes a quadruple band structure.

13. The photocatalytic system of claim 11, wherein:
each nanostructure of the array of nanostructures comprises a first side and a second side opposite the first side;
the first side faces away from the substrate;
the second side faces toward the substrate; and
a dopant concentration of the semiconductor composition decreases from the first side to the second side to establish a lateral dopant gradient.

14. The photocatalytic system of claim 11, further comprising first and second pluralities of catalyst nanoparticles disposed over the array of nanostructures, the catalyst nanoparticles of the first and second pluralities of catalyst nanoparticles being disposed on a water-oxidizing anode side and a proton-reducing cathode side of each nanostructure of the array of nanostructures, respectively.

15. The photocatalytic system of claim 14, wherein:
the semiconductor composition comprises indium gallium nitride doped with magnesium;
the substrate comprises silicon;
each catalyst nanoparticle of the first plurality of catalyst nanoparticles on the water-oxidizing anode side comprises cobalt oxide; and
each catalyst nanoparticle of the second plurality of catalyst nanoparticles on the proton-reducing cathode side comprises rhodium (Rh).

16. A method of fabricating a photocatalytic semiconductor device, the method comprising:
providing a substrate having a surface; and
forming an array of nanostructures on the surface of the substrate such that each nanostructure of the array of nanostructures extends outward from the surface of the substrate, each nanostructure of the array of nanostructures having a semiconductor composition, the semiconductor composition establishing a photochemical diode;
wherein the surface is nonplanar such that subsets of the array of nanostructures are oriented at different angles.

17. The method of claim 16, wherein providing the substrate comprises implementing a crystallographic etch procedure to define the surface.

18. The method of claim 17, wherein:
the crystallographic etch procedure comprises a wet etch procedure; and
the substrate comprises a silicon wafer of <100> orientation such that the wet etch procedure establishes that the surface comprises a pyramidal textured surface with faces oriented along <111> planes.

19. The method of claim 16, further comprising depositing first and second pluralities of catalyst nanoparticles across the array of nanostructures, the catalyst nanoparticles of the first and second pluralities of catalyst nanoparticles being disposed on a water-oxidizing anode side and a proton-reducing cathode side of each nanostructure of the array of nanostructures, respectively.

20. The method of claim 19, wherein depositing the first and second pluralities of catalyst nanoparticles comprises implementing first and second photo-deposition procedures to direct the first and second pluralities of catalyst nanoparticles to the water-oxidizing anode side and the proton-reducing cathode side of each nanostructure of the array of nanostructures, respectively.

21. A photocatalytic device comprising:
a substrate having a surface; and
an array of conductive projections supported by the substrate and extending outward from the surface of the substrate, each conductive projection of the array of conductive projections having a semiconductor composition, the semiconductor composition establishing a photochemical diode;
wherein:
each conductive projection comprises a cylindrically shaped nanostructure, and
the semiconductor composition comprises a lateral doping gradient.

22. A method of fabricating a photocatalytic semiconductor device, the method comprising:
providing a substrate having a surface; and
forming an array of nanostructures on the surface of the substrate such that each nanostructure of the array of nanostructures extends outward from the surface of the substrate, each nanostructure of the array of nanostructures having a semiconductor composition, the semiconductor composition establishing a photochemical diode;
wherein forming the array of nanostructures comprises implementing a molecular beam epitaxy procedure in which the substrate is rotated, and
wherein the semiconductor composition comprises a lateral doping gradient.
